(19) United States
(12) Patent Application Publication
(10) Pub. No.: US 2022/0270224 A1
(43) Pub. Date: Aug. 25, 2022

(54) IMAGE DEPENDENT CONTENT INTEGRATING METHOD

(71) Applicant: MERGERITY CO., LTD., Seoul (KR)

(72) Inventors: Pan Jong KIM, Seoul (KR); Bae Young MYUNG, Gimpo-si, Gyeonggi-do (KR); Sung Hoon YOO, Seoul (KR)

(21) Appl. No.: 17/635,621

(22) PCT Filed: Jul. 19, 2021
(86) PCT No.: PCT/KR2021/009288

§ 371 Date: Feb. 15, 2022

(30) Foreign Application Priority Data
Aug. 28, 2020 (KR) 10-2020-0109720
Oct. 20, 2020 (KR) 10-2020-0136028

(51) Int. Cl. G06T 5/50; G06F 16/583; G06F 3/04815

(52) U.S. Cl. CPC G06T 5/50; G06F 16/583; G06F 3/04815; G06T 2207/20221

(57) ABSTRACT

An image dependent content integrating method performed in a computer system includes a first data storing operation in which at least one processor included in the computer system stores a first image for a first object and a first dependent content dependent on the first object, a second data storing operation in which the at least one processor stores a second image for a second object and a second dependent content dependent on the second object, an indicator calculating operation in which the at least one processor calculates a probability indicator that the first object and the second object are the same object by comparing first object characteristic information for the first image with second object characteristic information for the second image, an image integrating operation in which the at least one processor stores the first image and the second image as an image for an integrated object, and a dependent content integrating operation in which the at least one processor stores the first dependent content and the second dependent content as dependent content for the integrated object when the probability indicator is equal to or greater than the reference value.

### TECHNICAL FIELD

The present disclosure relates to an image dependent content integrating method, and more particularly, to a method for integrating augmented reality images captured in different views and dependent content into a single image and storing the integrated single image.

### BACKGROUND ART

With the wide spread of terminals such as smartphones and tablet computers equipped with high-performance cameras become popular, it has become easy to take high-quality photos or videos of surrounding objects. In addition, it has also become easy to upload such images and content related thereto to a server via the Internet.

Recently, a method of imaging an object in multiple directions while a terminal rotates around at least a portion of the object, rather than imaging the object only in one direction using such a terminal, is supported. Using this method, shape information of an actual object may be better expressed because information from two or more views are collected for the object.

Various services using image information captured in multiple directions have been attempted. In order for these services to be smoothly provided, images captured in as many directions as possible for an object are required and a function of recognizing an object as the same object no matter in which direction the object is imaged. In addition, a function of recognizing various contents included in different images recognized as the same object as contents related to the same object.

Therefore, various attempts have been made on a method for solving the problem.

[Related art document] Korean Patent Registration No. 10-2153990

### DISCLOSURE

### Technical Problem

An aspect of the present disclosure provides a method for integrating different images obtained by imaging the same object and dependent content related to the corresponding image into a single image and dependent content, and storing and managing the single image and dependent content.

Another aspect of the present disclosure provides a method of providing dependent content uploaded from another terminal to the terminal when an image uploaded from any one terminal is an image of the same object as the image uploaded from the other terminal.

### Technical Solution

According to an aspect of the present disclosure, there is provided an image integrating method performed in a computer system including: an image storing operation in which at least one processor included in the computer system stores a first image of a first object and a second image of a second object; an object characteristic information generating operation in which the at least one processor generates first object characteristic information and second object characteristic information regarding at least one of information on an appearance and an outer surface of the respective objects from the first image and the second image; an indicator calculating operation in which the at least one processor calculates a probability indicator that the first object and the second object are the same object by comparing the first object characteristic information with the second object characteristic information; and an image integrating operation in which the at least one processor integrates the first image and the second image to an image for the same object and stores the integrated image when the probability indicator is equal to or greater than a reference value.

In the image integrating method according to an embodiment of the present disclosure, the first image and the second image may be augmented reality images.

In the image integrating method according to an embodiment of the present disclosure, in the object characteristic information generating operation, the appearance of the object may be analyzed to select any one of a plurality of reference appearances pre-stored in the computer system, and the object characteristic information may include information on any one selected reference appearance.

In the image integrating method according to an embodiment of the present disclosure, in the object characteristic information generating operation, the outer surface of the object may be divided by a dividing line in a vertical direction and divided into a plurality of partial images arranged in a horizontal direction, and the object characteristic information may include information on at any one of a pattern and a color of the partial image and text included in the partial image.

In the image integrating method according to an embodiment of the present disclosure, the object characteristic information generating operation may further include: a height recognizing operation of recognizing an image capture height of the object from the first image or the second image; and a height correcting operation of correcting the first image or the second image so that the image capture height becomes a predetermined reference height.

In the image integrating method according to an embodiment of the present disclosure, the indicator calculating operation may include: a vertical partial image identifying operation of identifying a vertical partial image divided by the dividing line in a vertical direction from the first object characteristic information and the second object characteristic information; and an overlapping region selecting operation of selecting at least one vertical partial image corresponding to an overlapping region by comparing respective vertical partial images of the first object characteristic information and the second object characteristic information.

In the image integrating method according to an embodiment of the present disclosure, the probability indicator may be calculated based on a correlation of at least one vertical partial image corresponding to the overlapping region, among the first object characteristic information and the second object characteristic information.

In the image integrating method according to an embodiment of the present disclosure, the at least one vertical partial image corresponding to the overlapping region may be a plurality of vertical partial images continuous with each other.

In the image integrating method according to an embodiment of the present disclosure, the image storing operation may include a first image storing operation of storing the first image and a second image storing operation of storing the second image, the object characteristic information generating operation may include: a first object characteristic information generating operation of generating the first object characteristic information and a second object characteristic information generating operation of generating the second object characteristic information, the second image storing operation may be performed after the first object characteristic information generating operation, and when the probability indicator is equal to or greater than the reference value, the image integrating method may further include an additional second image storing operation in which the at least one processor stores an additional second image added to the second image.

In the image integrating method according to an embodiment of the present disclosure, the second image and the additional second image may be captured from a single terminal connected to the computer system via a network.

In the image integrating method according to an embodiment of the present disclosure, when the probability indicator is equal to or greater than the reference value, the image integrating method may further include: an additional second image registration mode providing operation in which the at least one processor supports capturing and transmission of the additional second image to a terminal connected to the computer system via a network.

In the image integrating method according to an embodiment of the present disclosure, in the operation of providing the additional second image registration mode, the at least one processor may provide the additional second image registration mode such that a portion corresponding to the second image and a portion corresponding to the additional second image are displayed to be distinguished from each other in the terminal.

In the image integrating method according to an embodiment of the present disclosure, in the operation of providing the additional second image registration mode, the portion corresponding to the additional second image and the portion corresponding to the additional second image may be displayed in a virtual circular shape surrounding the second object, and the portion corresponding to the second image and the portion corresponding to the additional second image may be displayed in different colors.

According to another aspect of the present disclosure, there is provided a computer system including: a memory; and at least one processor connected to the memory and configured to execute instructions, wherein the at least one processor includes: an image storing unit configured to store a first image of a first object and a second image of a second object; an object characteristic information generating unit configured to generate first object characteristic information and second object characteristic information regarding at least one of information on an appearance and an outer surface of the respective objects from the first image and the second image; an indicator calculating unit configured to calculate a probability indicator that the first object and the second object are the same object by comparing the first object characteristic information with the second object characteristic information; and an image integrating unit configured to integrate the first image and the second image to an image for the same object and stores the integrated image when the probability indicator is equal to or greater than a reference value.

### Advantageous Effects

In the image dependent content integrating method according to an embodiment of the present disclosure different images obtained by imaging the same object and dependent content regarding the images may be integrated into a single image and dependent content so as to be stored and managed.

In addition, in the image dependent content integrating method according to an embodiment of the present disclosure, when an image uploaded from any one terminal is an image obtained by imaging the same object as an image uploaded from another terminal, dependent content uploaded from the other terminal may be provided to the terminal.

### DESCRIPTION OF DRAWINGS

FIG. 1 is a block diagram illustrating a connection relationship of a computer system in which an image integrating method of the present disclosure is performed.

FIG. 2 is a block diagram of a computer system for performing an image integrating method of the present disclosure.

FIG. 3 is a flowchart of an image integrating method according to an embodiment of the present disclosure.

FIG. 4 is a diagram schematically illustrating contents of a first image, a second image, first dependent content, and second dependent content according to an embodiment of the present disclosure.

FIG. 5 schematically illustrates an example of a method for a processor to generate object characteristic information from an object according to an embodiment of the present disclosure.

FIG. 6 is a view illustrating a partial image according to an embodiment of the present disclosure.

FIG. 7 is a view illustrating an example of an indicator calculating step according to an embodiment of the present disclosure.

FIG. 8 is a diagram illustrating an example of an image integrating step according to an embodiment of the present disclosure.

FIG. 9 is a flowchart illustrating an image integrating method according to another embodiment of the present disclosure.

FIG. 10 is a diagram schematically illustrating contents of a third image and third dependent content according to another embodiment of the present disclosure.

FIGS. 11 and 12 are diagrams showing examples of an additional image integrating step according to another embodiment of the present disclosure.

### BEST MODES

Hereinafter, embodiments of the present disclosure will be described in detail with reference to the accompanying drawings. In describing the present disclosure, if it is determined that a detailed description of known functions and components associated with the present disclosure unnecessarily obscure the gist of the present disclosure, the detailed description thereof will be omitted. The terms used henceforth are used to appropriately express the embodiments of the present disclosure and may be altered according to a person of a related field or conventional practice. Therefore, the terms should be defined on the basis of the entire content of this specification.

Technical terms used in the present specification are used only in order to describe specific exemplary embodiments rather than limiting the present disclosure. The terms of a singular form may include plural forms unless referred to the contrary. It will be further understood that the terms “comprise” and/or “comprising,” when used herein, specify the presence of stated features, integers, steps, operations, elements, and/or components, but do not preclude the presence or addition of one or more other features, regions, integers, steps, operations, elements, components, and/or groups thereof.

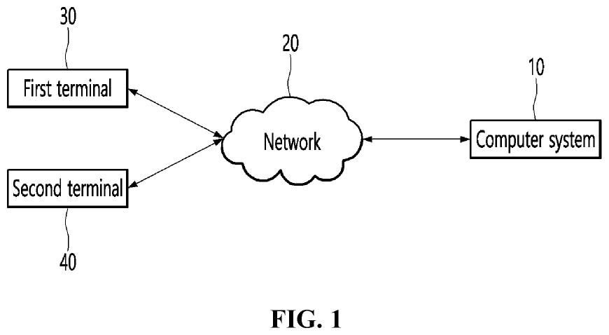

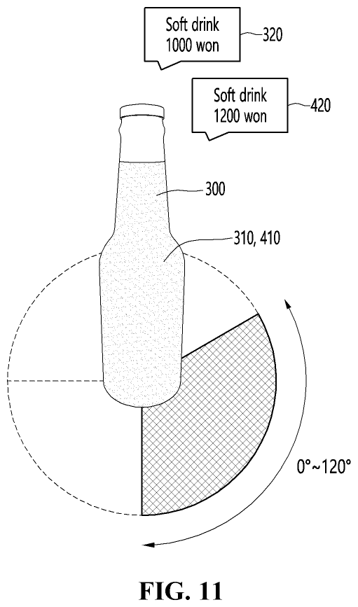

Hereinafter, an image dependent content integrating method according to an embodiment of the present disclosure will be described with reference to the accompanying FIGS. 1 to 12.

FIG. 1 is a diagram briefly illustrating a connection relationship of a computer system 10 in which an image integrating method of the present disclosure is performed.

Referring to FIG. 1, a computer system 10 of the present disclosure may be configured as a server connected to a network 20. The computer system 10 may be connected to a plurality of terminals via the network 20.

Here, a communication method of the network 20 is not limited, and a connection between each component may not be connected in the same network method. The network 20 may include not only a communication method using a communication network (e.g., a mobile communication network, wired Internet, wireless Internet, a broadcasting network, a satellite network, etc.) but also short-range wireless communication between devices. For example, the network 20 may include all communication methods through which objects may network, and is not limited to wired communication, wireless communication, 3G, 4G, 5G, or other methods. For example, the wired and/or network 20 may include a communication network based on one or more communication methods selected from the group consisting of local area network (LAN), metropolitan area network (MAN), global system for mobile network (GSM), enhanced data GSM environment (EDGE), high speed downlink packet access (HSDPA), wideband code division multiple access (W-CDMA), CDMA, time division multiple access (TDMA), Bluetooth, Zigbee, Wi-Fi, voice over Internet protocol (VoIP), LTE advanced, IEEE802.16m, WirelessMAN-Advanced, HSPA+, 3GPP long term evolution (LTE), mobile WiMAX (IEEE 802.16e), UMB (formerly EV-DO Rev. C), Flash-OFDM, iBurst and MBWA (IEEE 802.20) systems, HIPERMAN, beam-division multiple access (BDMA), world interoperability for microwave access (Wi-MAX), and ultrasound-based communication, but are not limited thereto.

The terminals may have a camera device capable of capturing an image. Terminals may include mobile phones, smartphones, laptop computers, digital broadcasting terminals, personal digital assistants (PDA), portable multimedia players (PMPs), navigation systems, slate PCs, tablet PCs, ultrabook, wearable devices (e.g., watch-type terminals (smartwatches), glass-type terminals (smart glasses), head mounted displays (HMDs), etc.

The terminals may include a communication module and transmit and receive wireless signals to and from at least one of a base station, an external terminal, and a server in a mobile communication network established according to technical standards or communication methods for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSDPA), long term evolution (LTE), long term evolution-advanced (LTE-A), etc.).

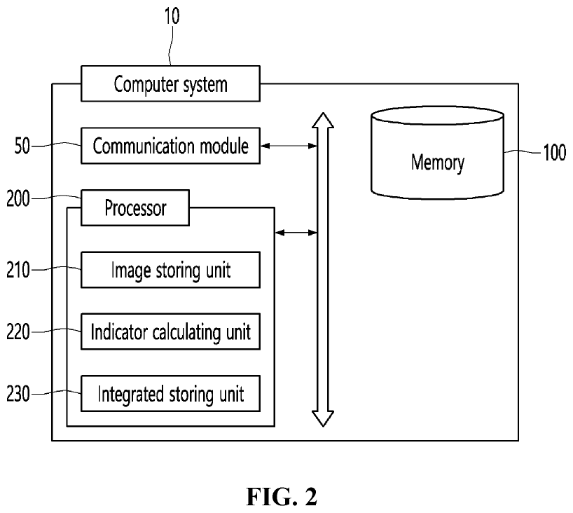

FIG. 2 is a block diagram of the computer system 10 for performing the image integrating method of the present disclosure.

Referring to FIG. 2, the computer system 10 may include a memory 100 and a processor 200. In addition, the computer system 10 may include a communication module 50 that may be connected to the network 20.

Here, the processor 200 is connected to the memory 100 and is configured to execute an instruction. The instruction refers to a computer readable instruction included in the memory 100.

The processor 200 includes an image storage unit 210, an indicator calculating unit 220, and an integrating storage unit.

The memory 100 may store a database including images and object characteristic information for the images.

Each part of the processor 200 described above will be described after the image integrating method is described.

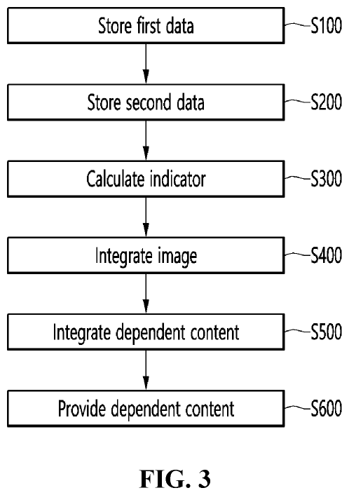

FIG. 3 is a flowchart of an image dependent content integrating method according to an embodiment of the present disclosure.

Referring to FIG. 3, the image dependent content integrating method of the present disclosure includes a first data storing step, a second data storing step, an indicator calculating step, an image integrating step, dependent content integrating step, and a dependent content providing step. Each of the steps described above is performed in the computer system 10. Specifically, each of the steps described above is performed by at least one processor 200 included in the computer system 10.

Each of the steps described above may be performed irrespective of the listed order, except when performed in the listed order due to a special causal relationship.

Hereinafter, the first data storing step and the second data storing step will be described.

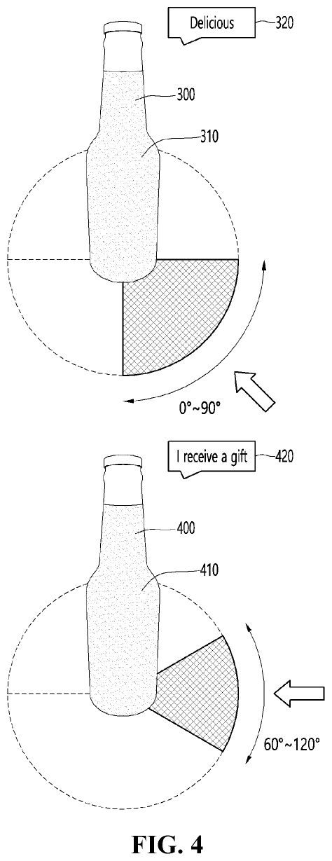

The first data storing step and the second data storing step will be described with reference to FIG. 4.

In the first data storing step, at least one processor 200 included in the computer system 10 stores a first image 310 of a first object 300 and a first dependent content 320 dependent on the first object 300.

In addition, in the second data storing step, at least one processor 200 included in the computer system 10 stores a second image 410 of the second object 400 and a second dependent content 420 dependent on the second object 400.

Here, the first data storing step and the second data storing step may be temporally spaced apart from each other. Also, the first data may be data received from the first terminal 30, and the second data may be data received from the second terminal 40. Also, the first terminal 30 and the second terminal 40 may be the same terminal or different terminals.

Here, the dependent content may refer to a review or purchase link for an object. That is, the first dependent content 320 may refer to a review or purchase link for the first object 300, and the second dependent content 420 may refer to a review or purchase link for the second object 400.

The computer system 10 receives a captured image and dependent content from at least one terminal through the network 20. The computer system 10 stores the received image and dependent content in the memory 100.

Here, the image may include a plurality of images. For convenience of description, it is assumed that the image includes a first image 310 and a second image 410. Also, it is assumed that the first image 310 is an image for the first object 300 and the second image 410 is an image for the second object 400.

Here, the image may be an augmented reality (AR) image. Also, the image may be an image captured to be generated, while turning around the object in a certain range. The image may be an image of the entire surrounding area (360°) of the object, but hereinafter, it is assumed that only a partial range (less than 360°) is imaged.

Here, the dependent content may include a plurality of dependent content. For convenience of description, it is assumed that the dependent content includes a first dependent content 320 and a second dependent content 420. Also, it is assumed that the first dependent content 320 is dependent content on the first object 300 and the second dependent content 420 is dependent content on the second object 400.

FIG. 4 is a diagram schematically illustrating the contents of the first image 310, the first dependent content 320, the second image 410, and the second dependent content 420.

The contents of the first image 310, the first dependent content 320, the second image 410, and the second dependent content 420 will be briefly described.

As described above, the first image 310 and the first dependent content 320 are an image and dependent content of the first object 300, and the second image 410 and the second dependent content 420 are an image and dependent content of the second object 400. However, the first object 300 and the second object 400 may be the same object. However, if the first image 310 and the second image 410 are obtained by imaging different portions thereof by different subjects and at different views based on different subjects, it may be difficult for the computer system 10 to recognize immediately whether the first object 300 and the second object 400 are the same object.

Here, when the first object 300 and the second object 400 are the same object, it means that they are not only physically the same object, but also physically different objects but have the same features in appearance and outer surface, that is, the same type of objects.

As shown in FIG. 4, the first image 310 may be an image obtained by imaging the first object 300 in a range of 0° to 90° based on a certain specific reference point. In addition, the second image 410 may be an image obtained by imaging the second object 400 which is the same as the first object 300 in a range of 60° to 120° based on the same specific reference point.

Similarly, the first dependent content 320 may be a first review (e.g., “delicious”) for the first object 300. In addition, the second dependent content 420 may be a second review (e.g., “I received a gift”) on the same first object 300 as the first object 300. Here, the first review and the second review may be reviews input by the same terminal or reviews input by different terminals.

Hereinafter, the indicator calculating step will be described. In order to perform the indicator calculating step, object characteristic information should be generated in order to compare the first object 300 characteristic information and the second object 400 characteristic information.

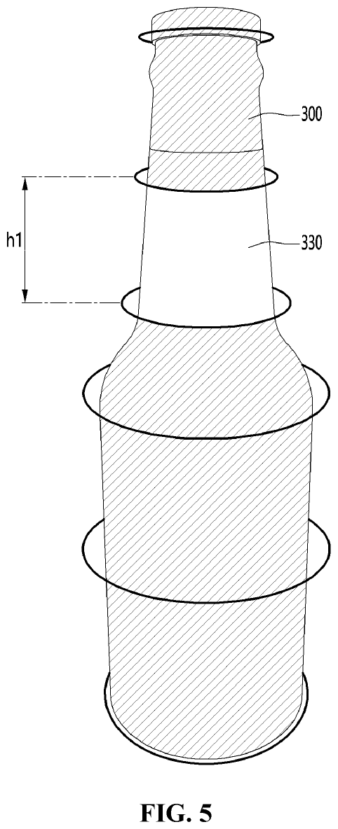

Generating of object characteristic information will be described with reference to FIGS. 5 to 7.

The object characteristic information refers to first object 300 characteristic information and second object 400 characteristic information regarding at least one of information on an appearance and outer surface of each object from the first image 310 and the second image 410.

The object characteristic information refers to information obtained by extracting a characteristic related to at least one of information on an appearance and an outer surface of an object by the processor 200 from an image.

The object characteristic information may include first object 300 characteristic information and second object 400 characteristic information. The first object 300 characteristic information is information on at least one of an appearance and an outer surface of the first object 300 extracted from the first image 310. The second object 400 characteristic information is information on at least one of an appearance and an outer surface of the second object 400 extracted from the second image 410.

In detail, the object characteristic information generates the first object 300 characteristic information and generates the second object 400 characteristic information that generates the second object 400 characteristic information. In addition, the first object 300 characteristic information and the second object 400 characteristic information may be generated to be temporally spaced apart from each other.

Specifically, first, a first data storing step may be performed, and first object 300 characteristic information may be generated. Thereafter, the second data storing step may be performed, and the second object 400 characteristic information may be performed.

FIG. 5 schematically illustrates an example of a method for the processor 200 to generate object characteristic information from an object.

Referring to FIG. 5, the object characteristic information may include any one information among a shape, color, length, interval, and ratio of a partial image 330.

Here, the partial image 330 refers to an image obtained by dividing an external appearance of an object by a dividing line in one direction. As shown in FIG. 5, the partial image 330 may be an image obtained by dividing the external appearance of an object by a dividing line in a horizontal direction and arranged in a vertical direction. One image may include a plurality of partial images 320.

These partial images 320 may be divided according to visual characteristics. For example, as shown in FIG. 5, one object may be divided by a plurality of dividing lines based on bending of an outer line.

The partial image 330 may have various visual characteristics. For example, as shown in FIG. 5, one partial image 330 may have characteristics such as a unique shape, color, length, interval, and ratio. Specifically, one partial image 330 among the partial images 320 shown in FIG. 5 may have a vertical length of hl, a color of light gold, and a cross-sectional shape of a trapezoidal shape with a wide bottom.

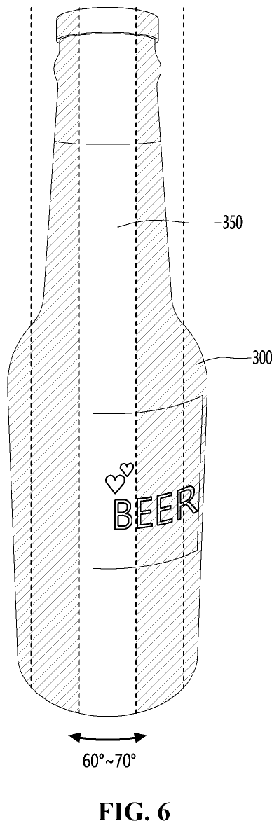

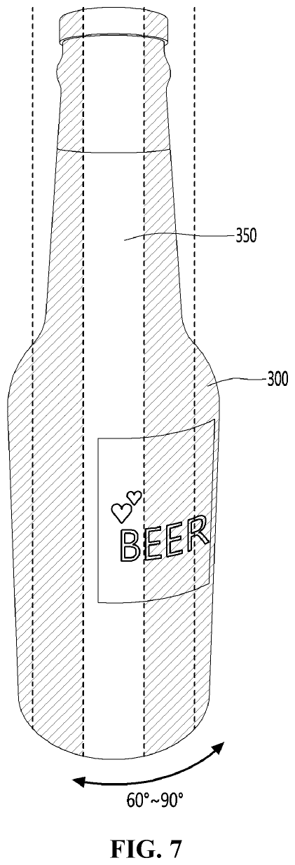

FIGS. 6 and 7 schematically illustrate another example of a method for the processor 200 to generate object characteristic information from an object.

Referring to FIG. 6, the object characteristic information may include information on any one of a pattern and a color of the partial image and text included in the partial image 330.

Here, the partial image 330 refers to an image obtained by dividing an outer surface of an object by a dividing line in one direction. As shown in FIG. 6, the partial image 321 may be an image obtained by dividing an outer surface of an object by a dividing line in a vertical direction and arranged in a horizontal direction. Also, one image may include a plurality of partial images 321.

The partial image 321 may be divided according to an angle at which the camera moves with respect to the center of the object. For example, as shown in FIG. 7, the partial image 321 may be divided into a range of 10° according to an image capture angle.

The partial image 321 may have various visual characteristics. For example, as shown in FIG. 6, one partial image 321 may have characteristics such as a unique pattern and color. Also, one partial image 321 may have characteristics for text included therein. Specifically, one partial image 330 among the partial images 321 shown in FIG. 6 may have a feature that there are two images of hearts on a white background and text B is described.

Hereinafter, an indicator calculating step will be described.

The indicator calculating step will be described with reference to FIG. 7.

In the indicator calculating step, at least one processor 200 included in the computer system 10 calculates a probability indicator that the first object 300 and the second object 400 are the same object by comparing the first object characteristic information and the second object 400 characteristic information.

The indicator calculating step may include a vertical partial image 350 identifying step and an overlapping region selecting step.

The vertical partial image 350 identifying step is a step of identifying the vertical partial image 350 divided by a dividing line in the vertical direction from the first object 300 characteristic information and the second object 400 characteristic information. The vertical partial image 350 may be divided according to an angle at which the camera moves with respect to the center of the object. For example, as shown in FIG. 7, the vertical partial image 350 may be divided into a range of 10° according to an image capture angle.

In the overlapping region selecting step, at least one vertical partial image 350 corresponding to the overlapping region is selected by comparing the vertical partial image 350 of each of the first object 300 characteristic information and the second object 400 characteristic information. For example, referring to FIG. 7, three vertical partial images 350 in the 10° range corresponding to the 60° to 90° range of the object based on a certain specific reference point may correspond to the overlapping region.

The overlapping region may include one or a plurality of vertical partial images 350. When the overlapping region includes a plurality of vertical partial images 350, the plurality of vertical partial images 350 may be continuous with each other. Referring to the example shown in FIG. 7, the three vertical partial images 350 are continuous with each other in the range of 60° to 90°.

Whether it corresponds to the overlapping region may be determined by comprehensively comparing information on the appearance and the outer surface of each vertical partial image 350.

The probability indicator that the first object 300 and the second object 400 are the same object may be calculated based on a correlation of at least one vertical partial image 350 corresponding to the overlapping region, among the first object image 300 characteristic information and the second object 400 characteristic information. That is, the vertical partial image 350 corresponding to the range of 0° to 60° that does not correspond to the overlapping region among the first object 300 characteristic information and the vertical partial image 350 corresponding to the range of 90° to 120° that does not correspond to the overlapping region among the second object 400 characteristic information may not be a basis for calculating the probability indicator.

Hereinafter, the image integrating step will be described.

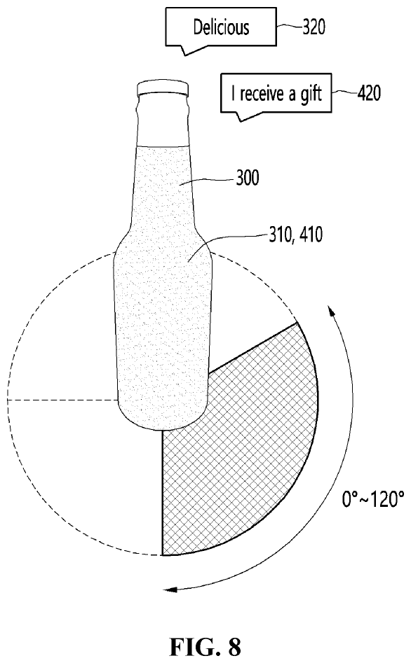

The image integrating step will be described with reference to FIG. 8.

The image integrating step is a step in which at least one processor 200 included in the computer system 10 integrates the first image 310 and the second image 410 into an image of the same object and stores the integrated image. This image integrating step is performed when the probability indicator in the indicator calculating step is greater than or equal to a predetermined reference value.

Referring to FIG. 8, when the probability indicator is equal to or greater than the predetermined reference value, the processor 200 may integrate the first image 310 and the second image 410 as an integrated image for the integrated object and store the integrated image, rather than recognizing the first image 310 and the second image 410 as images for the first object 300 and the second object 400 and storing and managing them, respectively.

Hereinafter, the dependent content integrating step will be described.

The dependent content integrating step will be described with reference to FIG. 8.

In the dependent content integrating step, at least one processor 200 included in the computer system 10 integrates the first dependent content 320 and the second dependent content 420 as dependent content for the same object and storing the same. This dependent content integrating step is performed when the probability indicator in the indicator calculating step is greater than or equal to a predetermined reference value.

Referring to FIG. 8, when the probability indicator is equal to or greater than a predetermined reference value, the processor 200 may not recognize, store, and manage the first dependent content 320 and the second dependent content 420 as dependent content for the first object 300 and the second object 400 any longer and integrate and store the first dependent content 320 and the second dependent content 420 as integrated dependent content for an integrated object. Accordingly, the first image 310, the second image 410, the first dependent content 320, and the second dependent content 420 are integrated and stored in the integrated object.

Hereinafter, an integrated fact providing step will be described.

In the integrated fact providing step, the processor 200 provides a fact that the first object 300 and the second object 400 are integrated to any one of the first terminal 30 and the second terminal 40, after the image integrating step and the dependent content integrating step are performed. This integrated fact providing step is performed when the probability indicator in the indicator calculating step is greater than or equal to a predetermined reference value. Through this, the user of the first terminal 30 or the second terminal 40 may know that the same object as the object uploaded by the user is already stored in the computer system 10.

In addition, the processor 200 provides at least one dependent content along with the integrated fact to any one of the first terminal 30 and the second terminal 40. The processor 200 may provide the dependent content according to a user's request or irrespective of a user's request. Through this, the user of the first terminal 30 or the second terminal 40 may be provided with at least one of the first dependent content 320 or the second dependent content 420 included in the first object 300 or the second object 400. For example, in a state in which the first image 310 and the first dependent content 320 (“delicious”) input from the first terminal 30 are stored in the memory 100, when the second image 410 and the second dependent content 420 (“I received a gift”) are input from the second terminal 40, the processor 200 calculates a probability indicator of the object, and when the probability indicator is greater than or equal to a predetermined reference value, the processor 200 provides the first dependent content 320 (“delicious”) together with the integrated fact to the second terminal 40.

Hereinafter, the dependent content providing step will be described.

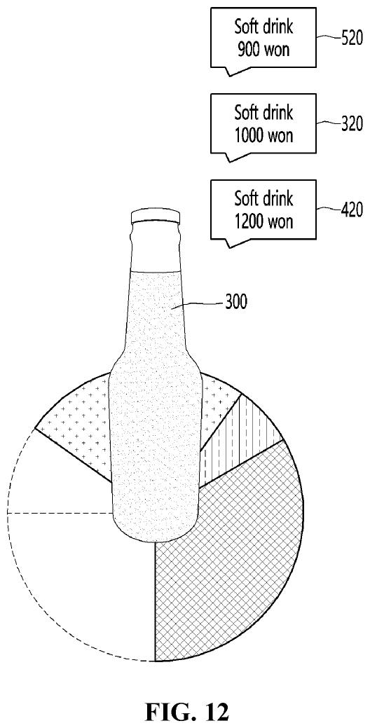

The dependent content providing step will be described with reference to FIG. 12.

The dependent content providing step is a step in which at least one processor 200 included in the computer system 10 provides dependent content to a terminal. This dependent content providing step is performed when the probability indicator is greater than or equal to a predetermined reference value in the indicator calculating step. In this case, dependent content that was originally dependent on different objects may be displayed and provided as dependent content dependent on one integrated object.

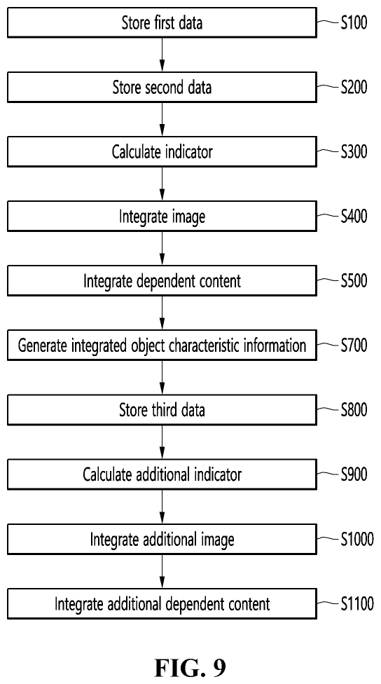

FIG. 9 is a flowchart of another embodiment of a method for integrating image dependent content according to the present disclosure.

Referring to FIG. 9, the image dependent content integrating method of the present disclosure includes a first data storing step, a second data storing step, an indicator calculating step, an image integrating step, a dependent content integrating step, an integrated object characteristic information generating step, a third data storing step, an additional indicator calculating step, an additional image integrating step, and an additional dependent content integrating step. Each of the steps described above is performed in the computer system 10. Specifically, each of the steps described above is performed by at least one processor 200 included in the computer system 10.

Each of the steps described above may be performed irrespective of the listed order, except when performed in the listed order due to a special causal relationship. Here, since the first data storing step, the second data storing step, the indicator calculating step, the image integrating step, and the dependent content integrating step are the same as described above, a description thereof will be omitted below.

Hereinafter, the integrated object characteristic information generating step will be described. In describing the integrated object characteristic information generating step will be described with reference to FIG. 8.

In the integrated object characteristic information generating step, at least one processor 200 included in the computer system 10 generates characteristic information on the first object 300 and the second object 400 integrated to an integrated object in the image integrating step and the dependent content integrating step. The integrated object characteristic information generating step is performed when the probability indicator in the indicator calculating step is greater than or equal to a predetermined reference value.

The integrated object characteristic information refers to integrated object characteristic information regarding at least one of information on an appearance and an outer surface of each object from the first image 310, the second image 410, or the first image 310 and the second image 410 in at least one processor 200 included in the computer system 10.

The integrated object characteristic information refers to information obtained by extracting a characteristic related to at least one of the information on the appearance and the outer surface of the integrated object from the image by the processor 200. A detailed method of generating the integrated object characteristic information is the same as the method of generating the object characteristic information in the indicator calculating step described above, and thus will be omitted below.

Hereinafter, the third data storing step will be described.

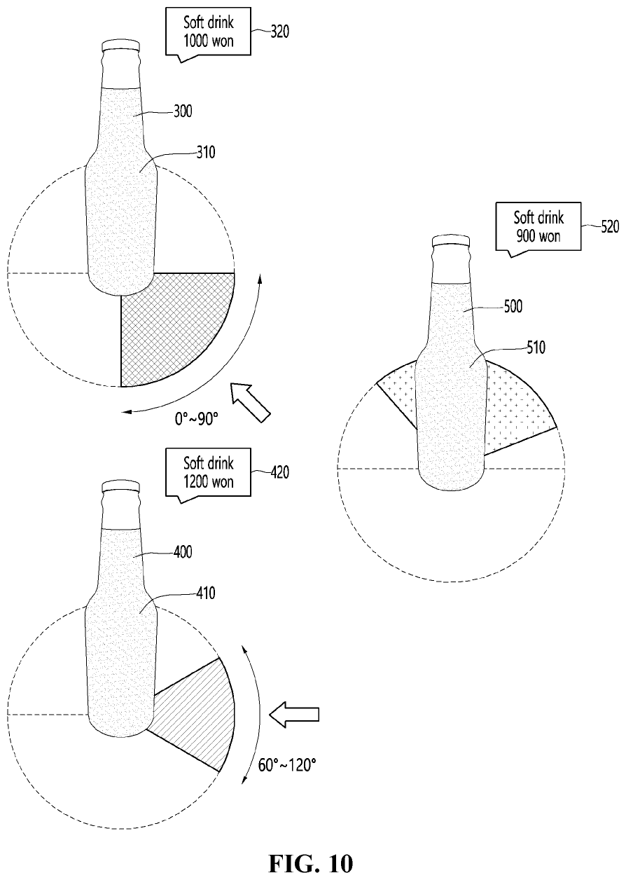

The third data storing step will be described with reference to FIG. 10.

In the third data storing step, at least one processor 200 included in the computer system 10 stores a third image 510 for a third object 500 and third dependent content 520 dependent on the third subject 500.

As shown in FIG. 10, the third dependent content 520 may be a review (e.g., “soft drink 900 won”) of a third user on the third object 500.

Here, the third data storing step may be temporally spaced apart from the first data storing step and the second data storing step. In addition, the third data may be data received from a third terminal, and the third terminal may be the same terminal as the first terminal 30 or the second terminal 40 or may be different terminals.

The third image 510 and the third dependent content 520 of the third data are the same as the contents of the image and dependent content described in the first data storing step and the second data storing step described above, and thus, a description thereof will be omitted.

Hereinafter, an additional indicator calculating step will be described.

In the step of extracting additional indicators, at least one processor 200 included in the computer system 10 compares the integrated object characteristic information and the third object 500 characteristic information and calculates a probability indicator that the integrated object and the third object 500 are the same object.

The method of calculating the probability indicator that the plurality of objects are the same object is the same as the method of calculating the probability indicator in the indicator calculating step described above, and thus, a description thereof will be omitted below.

Hereinafter, an additional image integrating step will be described.

The additional image integrating step will be described with reference to FIG. 12.

The additional image integrating step is a step in which at least one processor 200 included in the computer system 10 integrates and stores the integrated image and the third image 510 as an image for the same object. This additional image integrating step is performed when the probability indicator in the additional indicator calculating step is greater than or equal to a predetermined reference value.

Referring to FIG. 12, when the probability indicator is greater than or equal to a predetermined reference value, the processor 200 does not recognize, store, and manage the integrated image and the third image 510 as images for the integrated object and the third object 500 any longer but integrates and stores the integrated image and the third image 510 as an image for the integrated object.

Hereinafter, an additional dependent content integrating step will be described.

The additional dependent content integrating step will be described with reference to FIG. 12.

In the additional dependent content integrating step, at least one processor 200 included in the computer system 10 integrates and stores the integrated dependent content and the third dependent content 520 as dependent content for the same object. This additional dependent content integrating step is performed when the probability indicator in the additional indicator calculating step is greater than or equal to a predetermined reference value.

Referring to FIG. 12, when the probability indicator is equal to or greater than a predetermined reference value, the processor 200 does not recognize, store, and manage the integrated dependent content and the third dependent content 520 as dependent content for the integrated object and the third object 500, respectively, but integrate them as integrated dependent content for the integrated object. Accordingly, the integrated image, the third image 510, the integrated dependent content, and the third dependent content 520 are integrated and stored in the integrated object.

Here, the dependent content may include a field value of a predetermined field, and the field value may refer to a field value for a dependent content of an object, such as a price, the number of views, or the number of recommendations. Here, the predetermined field refers to a certain area in which a price, a number of views, a number of recommendations, etc. that may be included in dependent content are located. For example, if the dependent content includes a price-related field, the field value refers to a price.

The processor 200 sorts the dependent content for the integrated object as field values and provides the same to the terminal. If the field value is a price, the prices may be sorted in ascending or descending order and provided. FIG. 12 shows that a price is included in a field value of the dependent content, and the dependent content is sorted according to the ascending order of the price.

Hereinafter, an image dependent content integrating system according to the present disclosure will be described. The image dependent content integrating system will be described with reference to FIG. 2.

Since the image integrating system is a system of performing the image integrating method described above, a detailed description thereof will be replaced with the description of the image integrating method.

The image dependent content integrating system is implemented as the computer system 10. This computer system 10 includes the memory 100 and the processor 200. In addition, the computer may include a communication module 50 that may be connected to the network 20.

Here, the processor 200 is connected to the memory 100 and is configured to execute instructions. The instructions refer to computer-readable instructions included in the memory 100.

The processor 200 includes an image registration mode providing unit, an image storage unit 210, an object characteristic information generating unit, an indicator calculating unit 220, an integrated storing unit 230, and dependent content providing unit.

The memory 100 may store a database including a plurality of images, a plurality of dependent content, and object characteristic information for the plurality of images.

The image registration mode providing unit provides a user interface for capturing an image in the terminal and transmitting the captured image and dependent content to the computer system 10.

The image storage unit 220 stores the first image 310 and the first dependent content 320 for the first object 300, stores the second image 410 and the second dependent content 420 for the second object 400, and store the third image 510 and the third dependent content 520 for the third object 500. The image storage unit 220 performs the first data storing step, the second data storing step, and the third data storing step described above.

The object characteristic information generating unit 230 generates object characteristic information related to at least one of information on an appearance and outer surface of an object from each image. The object characteristic information generating unit performs the object characteristic information generating step and the integrated object characteristic information generating step described above.

The indicator calculating unit 220 calculates a probability indicator that the first object 300 and the second object 400 are the same object by comparing the first object 300 characteristic information and the second object 400 characteristic information. The indicator calculating unit 220 performs the indicator calculating step and the additional indicator calculating step described above.

When the probability indicator is equal to or greater than a reference value, the integrated storing unit 230 integrates and stores the first image 310 and the second image 410 as an image of the same object. When the probability indicator is equal to or greater than a reference value, the integrated storing unit 230 integrates the integrated image and the third image 510 to an image for the same object and stores the same. The integrated storing unit 230 performs the image integrating step and the additional image integrating step described above.

When the probability indicator is greater than or equal to the reference value, the dependent content providing unit provides the integrated fact to any one of the first terminal 30 and the second terminal 40. In addition, when the probability indicator is greater than or equal to the reference value, the dependent content providing unit provides at least one dependent content along with the integration fact. The dependent content providing unit sorts the dependent content for the integrated object as a field value and provides the same.

The technical features disclosed in each embodiment of the present disclosure are not limited only to the corresponding embodiment and may be combined and applied to different embodiments unless they are mutually incompatible.

Embodiments of the image integrating method and system of the present disclosure have been described. The present disclosure is not limited to the embodiments described above and the accompanying drawings, and various modifications and variations may be made from the viewpoint of a person skilled in the art to which the present disclosure pertains. Therefore, the scope of the present disclosure should be defined by the equivalents of claims of the present disclosure as well as the claims.
10: computer system
20: network
30: first terminal
40: second terminal
50: communication module
100: memory
200: processor
210: image storing unit
220: indicator calculating unit
230: integrated storing unit
300: first object
310: first image
320: first dependent content
330: partial image
350: vertical partial image
400: second object
410: second image
420: second dependent content
500: third object
510: third image
520: third dependent content

1. An image dependent content integrating method performed in a computer system, the image dependent content integrating method comprising:
a first data storing operation in which at least one processor included in the computer system stores a first image for a first object and a first dependent content dependent on the first object;
a second data storing operation in which the at least one processor stores a second image for a second object and a second dependent content dependent on the second object;
an indicator calculating operation in which the at least one processor calculates a probability indicator that the first object and the second object are the same object by comparing first object characteristic information for the first image with second object characteristic information for the second image;
an image integrating operation in which the at least one processor stores the first image and the second image as an image for an integrated object
a dependent content integrating operation in which the at least one processor stores the first dependent content and the second dependent content as dependent content for the integrated object when the probability indicator is equal to or greater than the reference value; and
an integrated object characteristic information generating operation in which the at least one processor integrates the first image and the second image to generate an integrated image and generates integrated object characteristic information from the integrated image.

2. The image dependent content integrating method of claim 1, wherein the first dependent content and the second dependent content include a review or a purchase link for the first object and the second object.

3. The image-dependent content integrating method of claim 1, further comprising:
a third data storing operation in which the at least one processor stores a third image for a third object and third dependent content dependent on the third object; and
an additional indicator calculating operation in which the at least one processor calculates an additional probability indicator that the third object and the integrated object are the same object by comparing third object characteristic information for the third image and the integrated object characteristic information.

4. The image dependent content integrating method of claim 1, wherein the first data is data received from a first terminal and the second data is data received from a second terminal.

5. The image dependent content integrating method of claim 1, further comprising:
an integrated fact providing operation in which the at least one processor provides an integrated fact to any one of a first terminal and a second terminal when the probability indicator is equal to or greater than the reference value.

6. The image dependent content integrating method of claim 5, further comprising an operation in which the at least one processor provides at least one dependent content together with the integrated fact.

7. The image dependent content integrating method of claim 1, wherein
the dependent content includes a field value of a predetermined field, and
wherein the image dependent content integrating method further comprising:
a dependent content providing operation in which the at least one processor sorts dependent content for the integrated object as the field value and provides the field value.

8. The image dependent content integrating method of claim 1, wherein the first image and the second image are augmented reality images.

9. The image dependent content integrating method of claim 1, wherein the first image and the second image are images captured, while turning around a surrounding of the first object and the second object in a certain range.

10. A computer system comprising:
a memory; and
at least one processor connected to the memory and configured to execute instructions,
wherein the at least one processor includes:
an image storing unit configured to store a first image for a first object and a first dependent content dependent on the first object and store a second image for a second object and a second dependent content dependent on the second object;
an indicator calculating unit configured to calculate a probability indicator that the first object and the second object are the same object by comparing first object characteristic information for the first image with second object characteristic information for the second image; and
an integrated storing unit configured to store the first image and the second image as images for an integrated object and store the first dependent content and the second dependent content as dependent contents for the integrated object, when the probability indicator is equal to or greater than the reference value,
wherein the at least one processor integrates the first image and the second image to generate an integrated image and generates integrated object characteristic information from the integrated image.
